(19) United States
(12) Patent Application Publication
(10) Pub. No.: US 2024/0104462 A1
(43) Pub. Date: Mar. 28, 2024

(54) SUPPLY CHAIN MANAGEMENT SYSTEM AND SUPPLY CHAIN MANAGEMENT METHOD

(71) Applicant: Hitachi, Ltd., Tokyo (JP)

(72) Inventors: Tazu NOMOTO, Tokyo (JP); Teppei INOUE, Tokyo (JP); Keiichi BAMOTO, Tokyo (JP); Ayaka YAMAGUCHI, Tokyo (JP)

(21) Appl. No.: 18/120,567

(22) Filed: Mar. 13, 2023

(30) Foreign Application Priority Data
Sep. 22, 2022 (JP) 2022-151157

(51) Int. Cl. G06Q 10/0631; G06Q 10/0635

(52) U.S. Cl. CPC G06Q 10/06315; G06Q 10/0635

(57) ABSTRACT

A supply chain management system is configured to create supply chain network information including information on a directed graph representing a multi-tiered supply chain network including tiers upstream and downstream of the target enterprise, acquire risk information on the multi-tiered supply chain network, detect, in the directed graph, a risk occurrence node influenced by a risk and a node of the target enterprise influenced by a defect of product supply at the risk occurrence node, search for a substituting node candidate for the risk occurrence node in a node group including a node of an enterprise outside the directed graph based on an item of the risk occurrence node, and present information on a change plan of the multi-tiered supply chain network obtained by adding the substituting node candidate to the directed graph.

### CLAIM OF PRIORITY

The present application claims priority from Japanese patent application JP 2022-151157 filed on Sep. 22, 2022, the content of which is hereby incorporated by reference into this application.

### BACKGROUND OF THE INVENTION

This invention relates to management of a supply chain.

In overall optimization of an enterprise-to-enterprise value chain, it is required to couple distribution, production, and procurement and purchase at customer demand start points through cooperation of enterprise-to-enterprise supply chains exceeding procurement cooperation, to thereby streamline a supply chain in an end-to-end form, eliminate unreasonableness, inconsistency, and waste, and increase resiliency. The supply chain is a series of overall business processes of products from procurement of raw materials and components, via production, stock management, and sales, to delivery. A risk, for example, a natural disaster or an industrial accident, which has occurred at any point of the supply chain influences component supply by an upstream supplier, and consequently also influences a production plan of a downstream enterprise.

As a related-art technology for managing a supply chain, there is JP 2020-144666 A. In JP 2020-144666 A, there is disclosed a value chain rating system which includes a processor configured to create a value chain based on at least one of a list of business partners, settlement information, and product information, calculate a substitution possibility of a supplier in the value chain, determine an enterprise rating of the supplier, and to calculate a rating of the value chain based on the substitution possibility and the enterprise rating of the supplier (see, for example, Abstract).

There are required an increase in on-time delivery rate, stock reduction, CO₂ reduction, and an increase in resiliency through streamlining of a supply chain operation in an end-to-end form coupling a plurality of tiers. However, an order placing party can recognize a state of a direct supplier, but has difficulty in recognizing states of suppliers on the upstream side thereof. A risk having occurred upstream in the multi-tiered supply chain influences supply plans of downstream enterprises. Similarly, a risk having occurred downstream in the multi-tiered supply chain also influences supply plans of upstream enterprises. There is thus desired a technology capable of effectively supporting risk management in the multi-tiered supply chain.

### SUMMARY OF THE INVENTION

An aspect of this invention is a supply chain management system, including: one or more arithmetic devices; and one or more storage devices configured to store programs executed by the one or more arithmetic devices, wherein the one or more storage devices are configured to store user enterprise information for managing information on a plurality of enterprises including a target enterprise, and wherein the one or more arithmetic devices are configured to: create, by referring to information representing flows of products in the plurality of enterprises, supply chain network information including information on a directed graph representing a multi-tiered supply chain network including tiers upstream and downstream of the target enterprise, each of nodes of the directed graph representing an enterprise and an item; acquire risk information on the multi-tiered supply chain network from one of disclosed information or non-disclosed information; detect, in the directed graph, a risk occurrence node influenced by a risk indicated by the risk information and a node of the target enterprise influenced by a defect of product supply at the risk occurrence node based on the risk information and the user enterprise information; search, by referring to the information representing the flows of the products in the plurality of enterprises, for a substituting node candidate for the risk occurrence node in a node group including a node of an enterprise outside the directed graph based on an item of the risk occurrence node; and present information on a change plan of the multi-tiered supply chain network obtained by adding the substituting node candidate to the directed graph.

According to the at least one aspect of this invention, it is possible to effectively manage the multi-tiered supply chain.

### BRIEF DESCRIPTION OF THE DRAWINGS

FIG. 1 is a diagram for illustrating an overview of supply chain management according to at least one embodiment of this specification.

FIG. 2 is a diagram for illustrating an example of a schematic configuration of the supply chain management system.

FIG. 3 is a diagram for illustrating a hardware configuration of the supply chain management apparatus.

FIG. 4 shows a configuration example of the user enterprise information.

FIG. 5 shows a configuration example of the SC network information.

FIG. 6 shows a configuration example of the recovery time information.

FIG. 7 shows a configuration example of the risk information.

FIG. 8 shows a configuration example of the item information.

FIG. 9 shows a configuration example of the SC network change plan.

FIG. 10 shows an example of information included in the order receiving and placing information.

FIG. 11A and FIG. 11B are flowcharts of the processing example of the supply chain management apparatus.

FIG. 12 is a flowchart of an example of the BOM estimation method.

FIG. 13A shows an example of order placing information having, in “order placing enterprise,” “order receiving enterprise” of an order placing record of the order placing information on the current enterprise A.

FIG. 13B shows an example of order placing information of the current enterprise A and an example of order placing information on the enterprise S1 on Tier 1.

FIG. 13C shows records in a BOM calculated from the correlating order placing records of FIG. 13B.

FIG. 14 shows an example of a risk display screen which presents a multi-tiered supply chain of a target enterprise and information on a risk thereto.

FIG. 15 shows an example of an SC network change plan display screen which presents information on the SC network change plan.

### DETAILED DESCRIPTION OF THE EMBODIMENTS

The following description of this invention is divided into a plurality of sections or a plurality of embodiments if necessary for convenience. However, unless explicitly noted otherwise, the embodiments or sections are not irrelevant to one another, and one is related to another as a modification example, detailed or supplementary description, or the like of a part of or the entirety of another. When the count of pieces of a component or the like (including the count, numerical value, amount, and range of a component) is mentioned in the following description of this invention, this invention is not limited to the particular count mentioned and the component count can be higher or lower than the particular count, unless explicitly noted otherwise or unless it is theoretically obvious that the component count is limited to the particular count.

This apparatus or system may be a physical computer system (one or more physical computers) or may be a system built on a computing resource group (a plurality of computing resources) such as a cloud infrastructure. The computer system or the computing resource group may include one or more interface devices (including, for example, a communication device and an input/output device), one or more storage devices (including, for example, a memory (main storage) and an auxiliary storage device), and one or more arithmetic devices.

When a function is implemented by an arithmetic device executing a program, predetermined processing is appropriately performed through use of, for example, a storage device and/or an interface device, and hence the function may be set as at least a part of the one or more arithmetic devices. The processing described with the function as the subject of a sentence may be set as processing performed by a system including the one or more arithmetic devices.

The program may be installed from a program source. Examples of the program source may include a program distribution computer and a computer-readable storage medium (for example, a computer-readable non-transitory storage medium). The description of each function is merely an example, and a plurality of functions may be combined into one function, or one function may be divided into a plurality of functions.

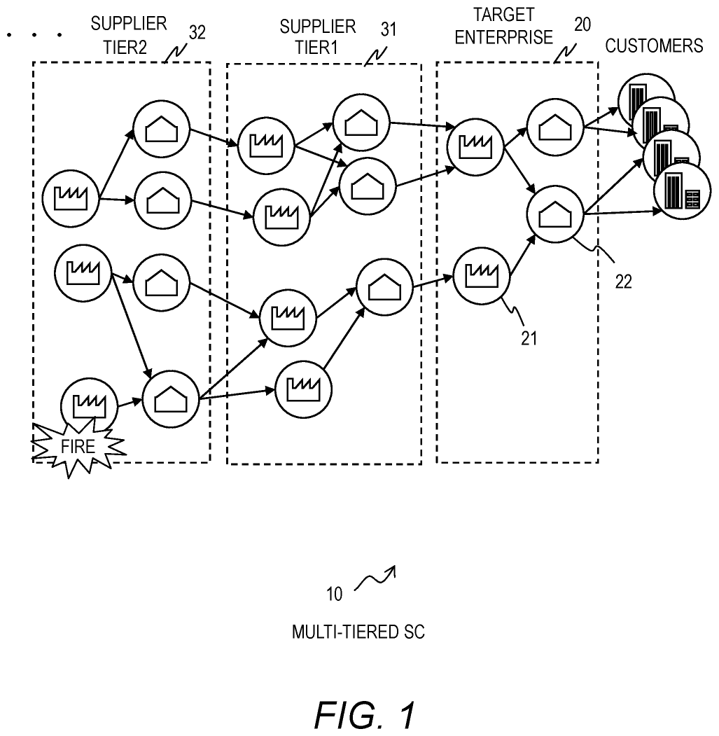

FIG. 1 is a diagram for illustrating an overview of supply chain management according to at least one embodiment of this specification. The supply chain is hereinafter also referred to as “SC.” In a directed graph of FIG. 1, a node represents a site and an arc represent transport of a product. Products of the same type may be produced at one or a plurality of production sites, and may be transported on one or a plurality of routes between the sites.

A supply chain management apparatus presents, to a user, information on a multi-tiered SC network 10 including a target enterprise 20, and supports management of this multi-tiered SC network 10 by the user. The SC network is formed of a plurality of enterprises, and those enterprises may be manufacturing enterprises, transport enterprises, wholesale enterprises, retail enterprises, and the like. An enterprise which supplies products to another enterprise is also referred to as “supplier.”

In this specification, an enterprise is an entity which conducts certain business, may be a profit organization or a non-profit organization, and may be an organization or an individual. Moreover, different enterprises are not always required to have different capitals, and may be, for example, different sections in the same company. The enterprise can also be referred to as “business entity.”

In FIG. 1, the target enterprise 20 includes a plurality of plants 21 and a plurality of warehouses 22, and sells products to customers. For example, products manufactured in the plant 21 are stored in the warehouse 22, and are then transported to order-placing enterprises. In FIG. 1, for the convenience of simple illustration, the one plant and the one warehouse are denoted by reference symbol 21 and reference symbol 22, respectively, as an example. In FIG. 1, reference symbols for plants and warehouses of other enterprises (suppliers) are also omitted in addition to those of the target enterprise 20.

In FIG. 1, there are illustrated two tiers 31 and 32 of suppliers upstream of the target enterprise 20. The supplier tier 31 immediately before the target enterprise 20 is referred to as “Tier 1,” and the supplier tier 32 upstream thereof is referred to as “Tier 2.” As the position moves upstream from the target enterprise 20, k of Tier k (k is a natural number) increases. The multi-tiered SC network 10 may include further upstream supplier tiers.

The supplier tier 31 being Tier 1 is formed of one or more enterprises which supply products (materials) to the target enterprise 20. When an enterprise is a manufacturer, the enterprise may include, for example, one or more plants and one or more warehouses. When the enterprise is a wholesaler, the enterprise may include one or more warehouses. Assets held by an enterprise are not particularly limited. The supplier tier 32 being Tier 2 is formed of one or more enterprises which supply products (materials) to the supplier tier 31 being Tier 1.

As described above, each supplier tier is formed of enterprises which supply products to a next downstream supplier tier. The multi-tiered SC network 10 is created such that the target enterprise 20 is a start point (most downstream point), and hence each supplier tier supplies, to the downstream supplier tier, products for the target enterprise 20 to conduct business.

In FIG. 1, the products supplied from each supply tier are materials required by the target enterprise 20 to manufacture final products to be sold to customers. In this case, the materials may be components having specific structure, compounds, and the like. The product manufactured by the target enterprise 20 may be an assembly such as a personal computer, or a product of a type different from the assembly, such as vegetable oil. The same applies to the products manufactured on each supply tier.

In the at least one embodiment, for the sake of understanding, description is given of a procedure for creating an upstream SC network in an example in which the downstream of the target enterprise represents the final customers which use and consume the products, but the configuration is not limited to this example, and a user of the multi-tiered SC network 10 may be an enterprise corresponding to the above-mentioned supply tier. In this case, the multi-tiered SC network 10 can be created by applying processing of an arithmetic module described later toward the upstream or the downstream.

In the at least one embodiment of this specification, a supply chain management apparatus presents, to a user, information on a risk that may influence the business of the target enterprise 20 in the multi-tiered SC network including the target enterprise 20. As a result, it is possible to effectively support the user in management of the supply chain of the target enterprise.

In FIG. 1, there is shown, as an example of the risk, a fire having occurred in one plant on the supply tier 32 being Tier 2. The fire is an example of the risk which influences the flows of the product supply in the multi-tiered supply chain. The risk to be presented can be any type of risk which may influence the product supply from the supplier, such as an industrial accident, a natural disaster, and labor unrest. The types of risk to be detected may be set in advance.

In the at least one embodiment of this specification, the supply chain management apparatus estimates a bill of material (BOM) of each enterprise based on order receiving and placing information among a plurality of enterprises. The order receiving and placing information is an example of information showing flows of products among a plurality of enterprises. Further, the supply chain management apparatus estimates the multi-tiered SC network based on the generated BOMs and the order receiving and placing information. As a result, it is possible to estimate the multi-tiered SC network without using design information on the products. The supply chain management apparatus may present information on the estimated multi-tiered SC network to the user without presenting the risk information.

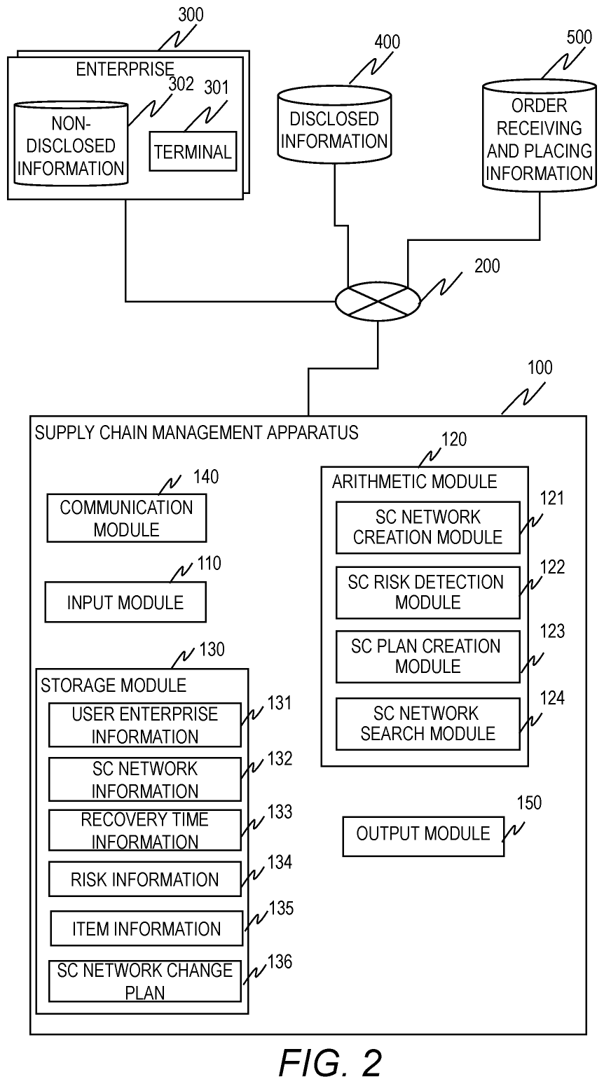

FIG. 2 is a diagram for illustrating an example of a schematic configuration of the supply chain management system. The supply chain management system includes a supply chain management apparatus 100 and a terminal 301 of a user enterprise 300 which uses a supply chain management service provided by the supply chain management apparatus 100. In FIG. 2, one of a plurality of enterprises and a terminal thereof are denoted, as an example, by reference symbols 300 and 301, respectively.

The supply chain management apparatus 100 and the terminal 301 of each enterprise are coupled to each other for mutual communication via a network 200. The network 200 is a public network, for example, the Internet, a local area network (LAN), a wide area network (WAN), or the like.

The supply chain management apparatus 100 can access disclosed information 400 and order receiving and placing information 500 via the network 200. The disclosed information 400 is information disclosed to the public on the Internet or the like, and includes disclosed information on various websites such as sites of various enterprises, news sites, and sites of social networking services (SNSs). As described later, the disclosed information 400 includes information on the risk which may influence the product supply from the supplier, such as an industrial accident, a natural disaster, and labor unrest.

The order receiving and placing information 500 represents, for example, order receiving and placing history managed by an order receiving and placing management system (not shown). The order receiving and placing management system uses electronic data interchange (EDI) to manage the order receiving and placing between enterprises. In the at least one embodiment of this specification, the supply chain management apparatus 100 estimates the multi-tiered SC network having the target enterprise as the start point based on the order receiving and placing information 500. As a result, it is possible to form a directed graph representing the multi-tiered SC network without using the design information on the products. Details of this point are described later.

The supply chain management apparatus 100 can further access or acquire specific non-disclosed information 302 on the user enterprise 300 which uses the supply chain management service after obtaining permission from the user enterprise. For example, information on a BOM of a specified user enterprise to generate the multi-tiered SC risk management information, information on a risk which has occurred in the enterprise to influence the product supply, and the like may be accessible or obtainable.

The supply chain management apparatus 100 manages enterprise activities from production to sales of the products. In the at least one embodiment of this specification, a logical configuration of the supply chain management apparatus 100 includes function modules which are an input module 110, an arithmetic module 120, a storage module 130, a communication module 140, and an output module 150.

The input module 110 receives information from the network 200 via the communication module 140 or from the input device of the supply chain management apparatus 100. The storage module 130 stores various types of information for managing the multi-tiered SC network. In the at least one embodiment of this specification, the storage module 130 stores user enterprise information 131, SC network information 132, recovery time information 133, risk information 134, item information 135, and an SC network change plan 136. Details of the information stored in the storage module 130 are described later.

The arithmetic module 120 executes processing for managing the multi-tiered SC network of the target enterprise. In the at least one embodiment of this specification, the arithmetic module 120 includes an SC network creation module 121, an SC risk detection module 122, an SC plan creation module 123, and an SC network search module 124.

The SC network creation module 121 creates SC network information 132 which relates to products dealt in by an enterprise to be managed, and simulates flows of items (multi-tiered SC network) from the procurement of the materials to the sales of the products through use of nodes, arcs, and component configurations.

The SC risk detection module 122 searches the disclosed information 400 or non-disclosed information (not shown) for risk information on the nodes or the arcs of the SC network information 132. The SC plan creation module 123 receives the SC risk as input to create an SC network change plan for the target enterprise in a portion directly relating to the target enterprise.

When the change plan does not satisfy a predetermined criterion (for example, a predetermined risk is equal to or less than a criterion), the SC network search module 124 searches for a node substituting a node at which the risk has occurred. The SC plan creation module 123 adds a retrieved substituting node to the multi-tiered SC network information on the target enterprise, and presents a result. The SC plan creation module 123 may generate a supply plan in the changed multi-tiered SC network.

The output module 150 outputs management information on the multi-tiered SC network to be presented to the user to an external device (for example, the terminal 301 of each enterprise) via the communication module 140 or to an output device, for example, a display device of the supply chain management apparatus 100.

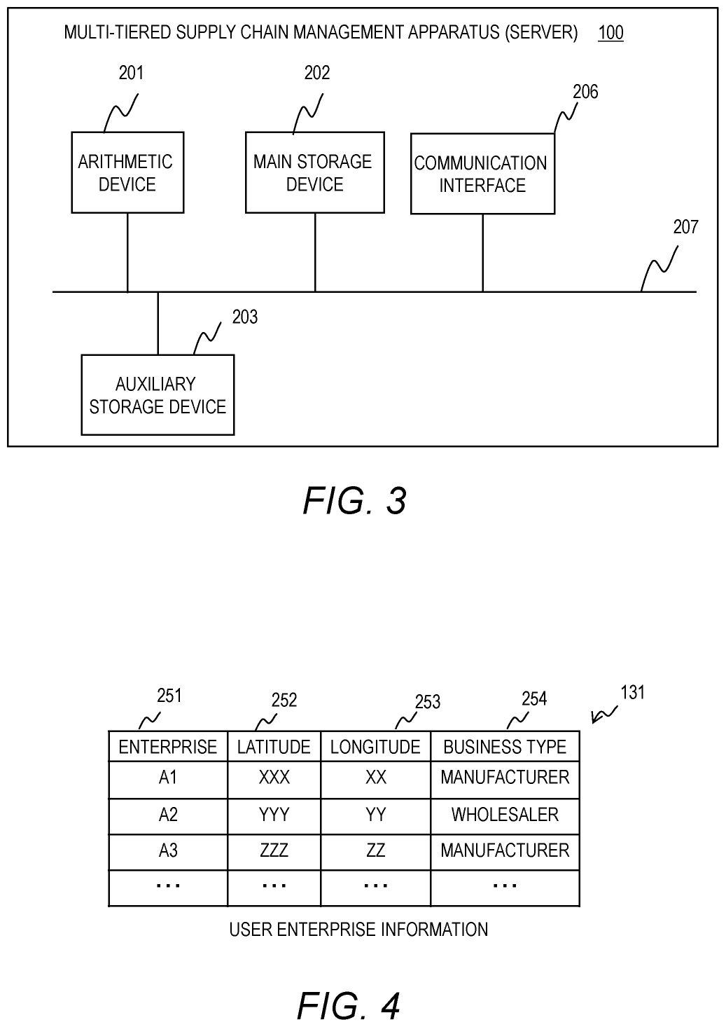

FIG. 3 is a diagram for illustrating a hardware configuration of the supply chain management apparatus 100. The supply chain management apparatus 100 includes a main storage device 202 formed of a volatile memory device such as a RAM and an auxiliary storage device 203 formed of an appropriate nonvolatile memory device such as a solid state drive (SSD) or a hard disk drive.

The supply chain management apparatus 100 further includes an arithmetic device 201 such as a CPU which reads out a program stored in the auxiliary storage device 203 or the like onto the main storage device 202, for example, to execute the program, to thereby execute overall control for the apparatus itself, and executes various types of determination, arithmetic operation, and control processing.

The supply chain management apparatus 100 includes a communication interface 206 to be used to couple to the network to transmit and receive data. Those components of the supply chain management apparatus 100 can communicate to and from each other via an internal bus 207. The supply chain management apparatus 100 may further include an input device such as a keyboard, a mouse, and a touch panel which receive an input operation from the user, and an output device such as a display which displays a processing result to the user.

In the auxiliary storage device 203, in addition to programs for implementing functions required as the supply chain management apparatus 100 in the at least embodiment, information required for various types of processing and information generated by the programs is stored. The function modules of the supply chain management apparatus 100 of FIG. 2 can be implemented by, for example, the arithmetic device 201 operating along with other hardware components in accordance with predetermined programs.

The supply chain management apparatus 100 may be a physical computer system (one or more physical computers) or may be a system built on a computing resource group (a plurality of computing resources) such as a cloud infrastructure. The computer system or the computing resource group includes one or more interface devices, one or more storage devices (including, for example, a main storage device and an auxiliary storage device), and one or more arithmetic devices.

When a function is implemented by the arithmetic device executing the program, predetermined processing is appropriately performed through use of, for example, the storage device and/or the interface device, and hence the function may be set as at least a part of the arithmetic device. The processing described with the function as the subject of a sentence may be set as processing performed by a system including the arithmetic device or a processor thereof.

The program may be installed from a program source. Examples of the program source may include a program distribution computer or a computer-readable storage medium (for example, a computer-readable non-transitory storage medium). The description of each function is merely an example, a plurality of functions may be combined into one function, or one function may be divided into a plurality of functions.

Description is now given of an example of the information stored in the storage module 130. FIG. 4 shows a configuration example of the user enterprise information 131. The user enterprise information 131 is registered in advance in the supply chain management apparatus 100.

The user enterprise information 131 indicates information on the user enterprise to which the supply chain management apparatus 100 provides services. The user enterprise information 131 includes an enterprise field 251, a latitude field 252, a longitude field 253, and a business type field 254. The enterprise field 251 indicates an identifier of an enterprise. The latitude field 252 and the longitude field 253 indicate a location of the enterprise. The business type field 254 indicates a business type to which the enterprise belongs. The user enterprise information 131 may include other information, a part of the information may be omitted, and the position information may be represented in a form (for example, address) different from the latitude and the longitude.

In the at least one embodiment of this specification, the supply chain management apparatus 100 generates, for a target enterprise selected from the enterprises indicated by the user enterprise information 131, information for managing a multi-tiered SC network of this target enterprise. Moreover, the enterprise of the multi-tiered SC network managed by the supply chain management apparatus 100 is managed through use of the user enterprise information 131.

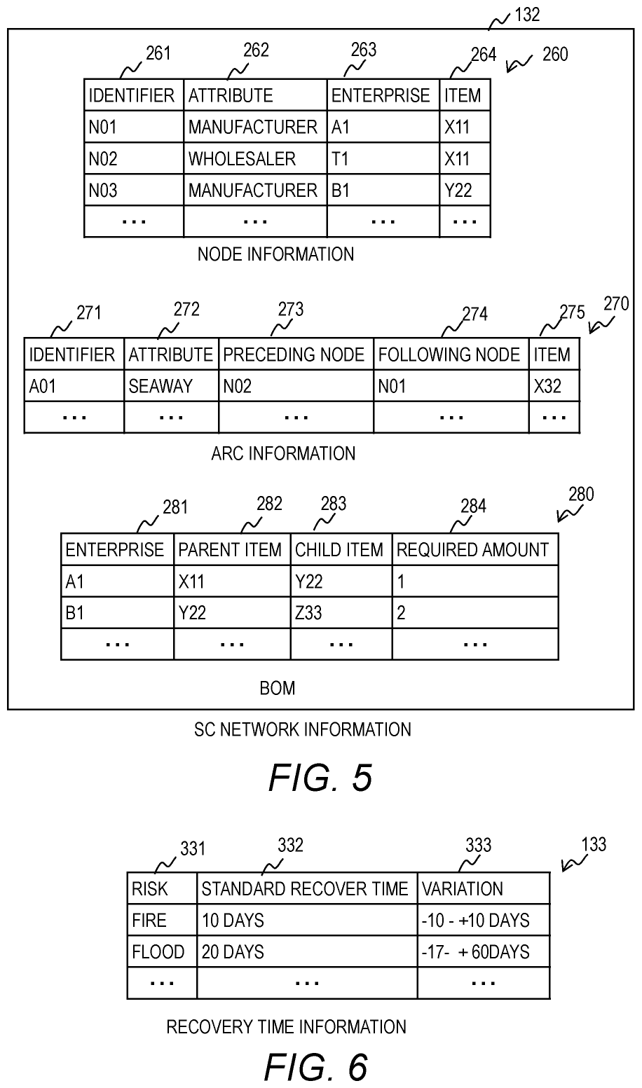

FIG. 5 shows a configuration example of the SC network information 132. In the at least one embodiment of this specification, the SC network information 132 is generated by the SC network creation module 121. Details of a method for the creation are described later. The SC network information 132 includes a directed graph and BOMs representing the multi-tiered SC network for the target enterprise.

The SC network information 132 includes node information 260, arc information 270, and a BOM 280. The node information 260 and the arc information 270 indicate information on nodes and arcs of the directed graph, respectively. The BOM 280 indicates relationships between products, that is, products (child items) serving as materials of each product (parent item) in the multi-tiered SC network.

In the example of FIG. 5, the node information 260 includes an identifier field 261, an attribute field 262, an enterprise field 263, and an item field 264. Each node in the directed graph represents a product of an enterprise. The identifier field 261 indicates an identifier of the node. The attribute field 262 indicates a business type of an enterprise of the node and matches the information indicated by the business type field 254 of the user enterprise information. The enterprise field 263 indicates an identifier of the enterprise of the node and matches the information indicated by the enterprise field 251 of the user enterprise information. The item field 264 indicates an item (for example, model number) of the product of the node. The item is a product name for uniquely identifying the product in the enterprise.

The arc information 270 includes an identifier field 271, an attribute field 272, a preceding node field 273, a following node field 274, and an item field 275. The arc in the directed graph indicates information on transport of a product between enterprises. The identifier field 271 indicates an identifier of an arc. The attribute field 272 indicates a type of a transport path. The preceding node field 273 indicates a start node of the arc, that is, an identifier of a node of a transport source of a product. The following node field 274 indicates an end node of the arc, that is, an identifier of a node of a transport destination of the product. The item field 275 indicates an item of the product transported from the preceding node to the following node.

One BOM 280 indicates a BOM of one enterprise. The SC network information 132 includes a BOM 280 of each of a plurality of enterprises. The BOM 280 includes an enterprise field 281, a parent item field 282, a child item field 283, and a required amount field 285. The BOM 280 indicates products serving as materials of a product in the multi-tiered SC network.

The enterprise field 281 indicates an order receiving enterprise of a product indicated by the child item field 283. The parent item field 282 indicates an item of a parent product dealt in by the enterprise of the BOM 280. The child item field 283 indicates an item of a child product serving as a material of the parent product. The required amount field 284 indicates an amount of units of the product of the child item required for one unit of the product of the parent item.

FIG. 6 shows a configuration example of the recovery time information 133. The recovery time information 133 is registered in advance in the supply chain management apparatus 100. The recovery time information 133 indicates a recovery time from a risk to the multi-tiered SC network. The recovery time information 133 includes a risk field 331, a standard recovery time field 332, and a variation field 333.

The risk field 331 indicates a type of the risk to the multi-tiered SC network. The standard recovery time field 332 is a standard time required for recovery from the risk. The variation field 333 indicates a variation from the standard recovery time of the recovery time from the risk.

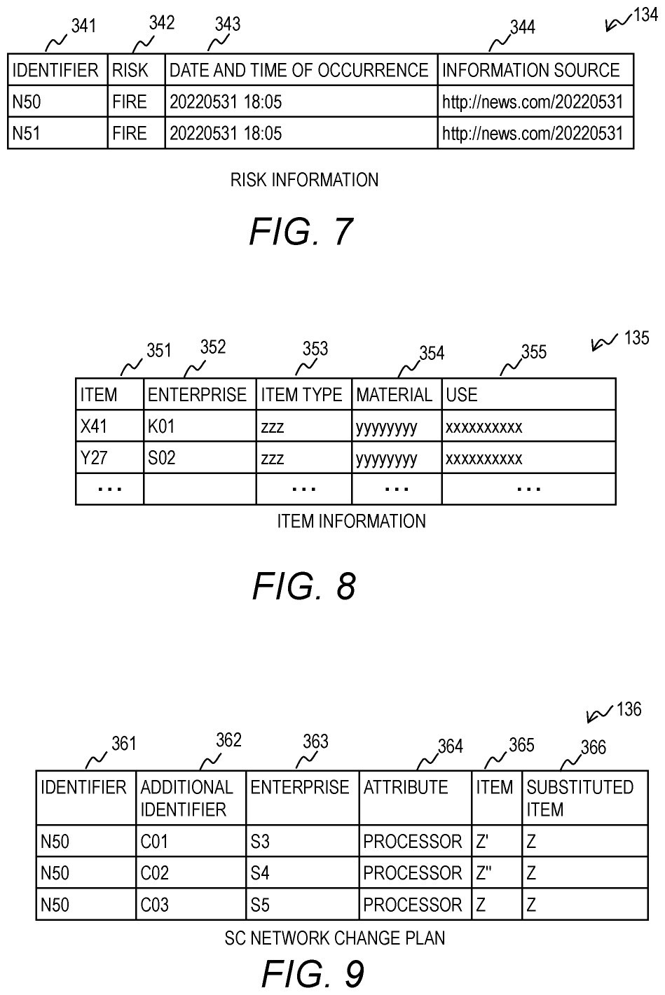

FIG. 7 shows a configuration example of the risk information 134. In the at least one embodiment of this specification, the risk information 134 is created by the SC risk detection module 122. The risk information 134 indicates information on a risk having occurred in the multi-tiered network indicated by the SC network information 132 and nodes influenced by this risk. An extracted risk is a risk estimated to influence a lead time in the multi-tiered SC network indicated by the SC network information 132.

The SC risk detection module 122 searches, for example, the disclosed information 400 and the non-disclosed information on the user enterprise, to thereby acquire the information on the risk to the multi-tiered SC network. The SC risk detection module 122 may use a service for supplying information on a risk to a supply chain, and may acquire the information on the risk to the multi-tiered SC network from a provider of this service. A service provision fee is paid to the service provider. The types of risk information to be collected are determined in advance. A risk relating to a certain enterprise can be collected by, for example, searching disclosed information and non-disclosed information for combinations of the risk specified in advance and enterprise-related information such as an enterprise name and a location of the enterprise.

In the example of FIG. 7, the risk information 134 includes an identifier field 341, a risk field 342, a date-and-time of occurrence field 343, and an information source field 344. The identifier field 341 indicates an identifier of a node influenced by a risk having occurred. The risk field 342 is a type of the risk having occurred. The date-and-time of occurrence field 343 indicates a date and time of occurrence of the risk. The information source field 344 indicates an information source from which information on the risk is acquired.

A part of the information of the risk information 134 exemplified in FIG. 7 may be omitted, and other information may be added. For example, the information on the information source may be omitted, and information on a place of occurrence of the risk and information on an estimated date and time of settlement of the risk having occurred may be included.

FIG. 8 shows a configuration example of the item information 135. The item information 135 is created by, for example, the SC network creation module 121. The item information 135 indicates information on attributes of items (products) dealt in by the user enterprises managed by the supply chain management apparatus 100. The SC network creation module 121 can acquire the information to be included in the item information 135 from the order receiving and placing information 500, the disclosed information 400, or the non-disclosed information.

The item information 135 includes an item field 351, an enterprise field 352, an item type field 353, a material field 354, and a use field 355. The item field 351 and the enterprise field 352 indicate an item of a product and an enterprise dealing in the product, respectively. The item type field 353, the material field 354, and the use field 355 indicate attributes of the product indicated by the item. The fields indicating the attributes of the product may be a combination of fields different from the example of FIG. 7.

FIG. 9 shows a configuration example of the SC network change plan 136. The SC plan creation module 123 generates a change plan for the multi-tiered SC network for the risk indicated by the risk information 134. The SC plan creation module 123 includes information on change points of a change plan into the SC network change plan 136. The SC network change plan 136 is presented to the user. Details of a method of generating the SC network change plan 136 are described later.

The SC network change plan 136 of FIG. 9 indicates three candidate nodes to be added to the multi-tiered SC network of the target enterprise indicated by the SC network information 132. Each record indicates information on the candidate node. A node having an identifier N50 is a node of a product a required amount of which cannot be supplied due to a defect in the supply (for example, stop of the supply) as a result of influence of a risk having occurred. Influenced nodes are indicated in the risk information 134.

The SC network change plan 136 of FIG. 9 includes an identifier field 361, an additional identifier field 362, an enterprise field 363, an attribute field 364, an item field 365, and a substituted item field 366. The identifier field 361 indicates an identifier of a node which cannot execute required supply due to a risk having occurred. The additional identifier field 362 indicates an identifier of a candidate node substituting the node indicated by the identifier field 361.

The enterprise field 363 indicates an enterprise of the candidate node. The attribute field 364 indicates a business type of the candidate node. The information in the attribute field 364 matches the information in the business type field 254 of the user enterprise information 131. The item field 365 indicates an item of a product of the candidate node. The substituted item field 366 indicates the item the supply of which is estimated to stagnate due to the risk having occurred.

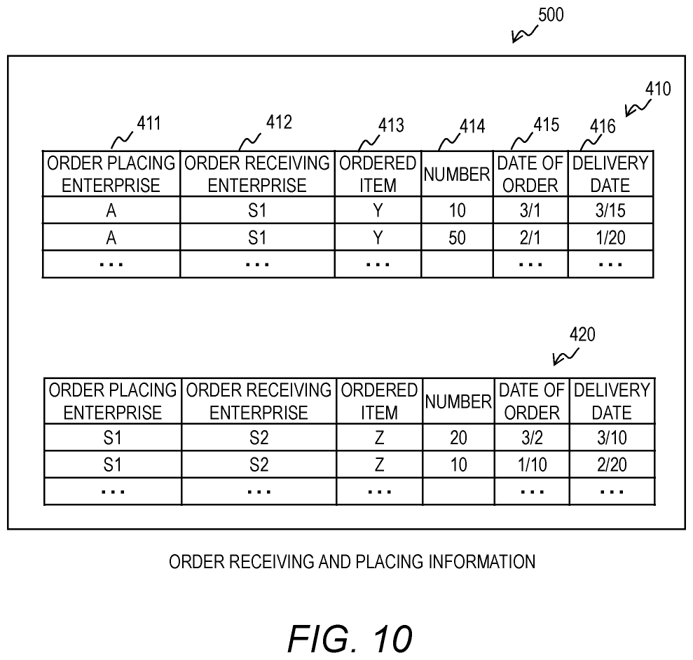

FIG. 10 shows an example of information included in the order receiving and placing information 500. The order receiving and placing information 500 indicates a history of receiving and placing of orders between the enterprises indicated by the user enterprise information 131. The supply chain management apparatus 100 can freely access the order receiving and placing information 500. The supply chain management apparatus 100 can estimate nodes of the products dealt in by the user enterprise, information on arcs between those nodes, and the BOM from the order receiving and placing information 500. Details are described later.

The order receiving and placing information 500 indicates information on placing of orders from each enterprise to other enterprises. In FIG. 10, as an example, order placing information from two enterprises to other enterprises is shown. Order placing information 410 indicates information on placing of orders from an enterprise A to other enterprises. Order placing information 420 indicates information on placing of orders from an enterprise S1 to other enterprises. The order placing information 410 and the order placing information 420 have the same configuration, and hence details of the order placing information 410 are now described as an example.

The order placing information 410 includes an order placing enterprise field 411, an order receiving enterprise field 412, an ordered item field 413, a number field 414, a date of order field 415, and a delivery date field 416. One record indicates information on placing of an order for one product for one time.

The order placing enterprise field 411 indicates an enterprise which orders a product. Only one user enterprise is indicated by the order placing enterprise field 411 in the order placing information 410. The order receiving enterprise field 412 indicates an enterprise which receives the order from the enterprise indicated by the order placing enterprise field 411. The order receiving enterprise field 412 indicates all user enterprises which receive the order from the enterprise indicated by the order placing enterprise field 411. The ordered item field 413 indicates an ordered product. The number field 414 indicates the number of the ordered products. The date of order field 415 indicates a date of order. The delivery date field 416 indicates a delivery date of the ordered items.

Description is now given of an example of processing of the supply chain management apparatus 100. The supply chain management apparatus 100 receives specification of a target enterprise from the enterprise field 251 indicated by the user enterprise information 131, and generates management information on a multi-tiered SC network which enables supply of products dealt in by this enterprise to downstream. In the at least one embodiment of this specification, the management information includes information on a risk which may influence the multi-tiered SC network. The management information is presented to the user to support the multi-tiered SC risk management by the user.

In the at least one embodiment of this specification, the supply chain management apparatus 100 generates change plans for the multi-tiered SC network against the risk, and presents the change plans to the user. As a result, the management of the multi-tiered SC by the user is facilitated.

In the at least one embodiment of this specification, the supply chain management apparatus 100 estimates, based on the order receiving and placing information 500, a multi-tiered SC network including a tier further upstream of a tier immediately upstream of the target enterprise and enterprises further downstream of enterprises immediately downstream of the target enterprise. As a result, it is possible to generate and visualize information for the multi-tiered SC management without using the design information on the products.

In the at least one embodiment of this specification, the supply chain management apparatus 100 uses the order receiving and placing information 500 to estimate BOMs. A BOM on a certain tier enables generation of information on coupling between this tier and the tier immediately upstream. It is possible to estimate the flows of the products in the multi-tiered SC network for the products dealt in by the target enterprise by tracing BOMs on each tier. The multi-tiered SC network may be created from information indicating the flows of the products between the user enterprises of another type. For example, a BOM of each user enterprise can be obtained, and hence the multi-tiered SC network may be created based on those BOMs. Information on nodes and arcs of each user enterprise may be set in advance.

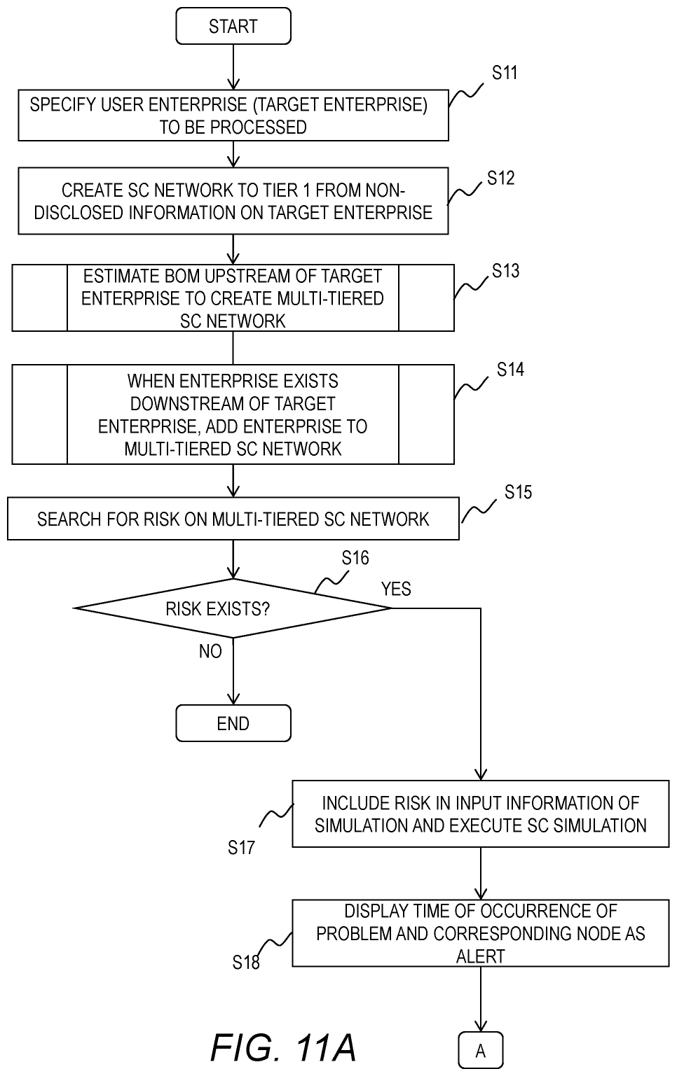

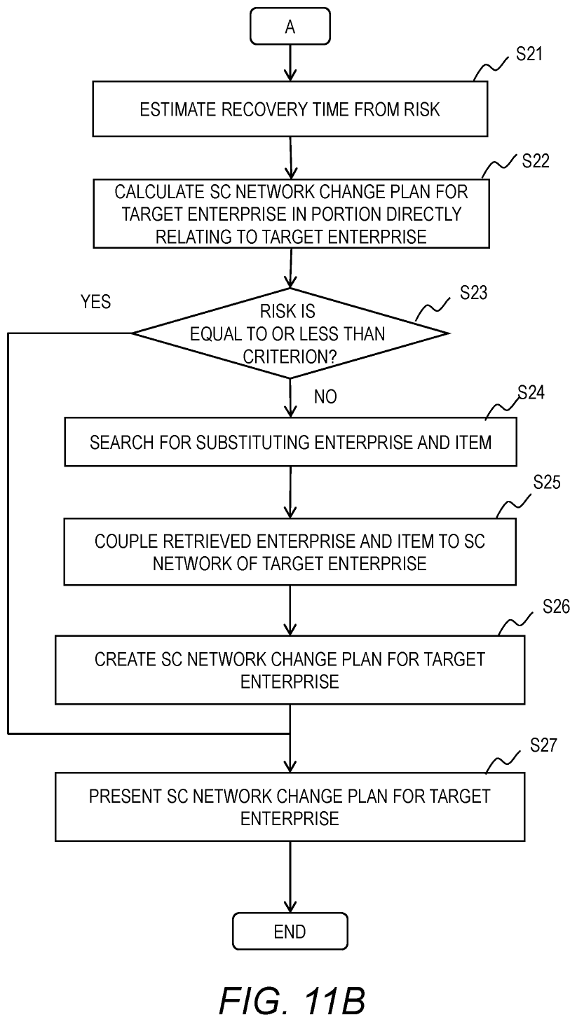

FIG. 11A and FIG. 11B are flowcharts of the processing example of the supply chain management apparatus 100. With reference to FIG. 11A, the input module 110 first receives the specification of a target enterprise from the terminal 301 of this target enterprise 300 via the communication module 140 and the network 200 (Step S11). The target enterprise is an enterprise for which risk management information on the multi-tiered SC network is to be generated.

After that, the SC network creation module 121 refers to the non-disclosed information 302 on the target enterprise to create the SC network from the target enterprise to Tier 1, and includes this SC network in the SC network information 132 (Step S12). For example, the SC network creation module 121 acquires a BOM between the target enterprise and each enterprise on Tier 1 from the non-disclosed information 302, and generates nodes of the target enterprise and each enterprise of Tier 1 and arcs coupling the nodes to each other from the BOM. As described with reference to FIG. 5, each node indicates information on an enterprise and a product dealt in by this enterprise, and the arc indicates the form of the transport of a product between enterprises.

After that, the SC network creation module 121 estimates the BOMs of tiers upstream of the target enterprise, that is, Tier 1 and tiers upstream thereof, and the BOMs of enterprises downstream of the target enterprise, and creates the multi-tiered SC network (current multi-tiered SC network) having the target enterprise as the start point based on the estimated BOMs (Step S13 and Step S14). The SC network creation module 121 estimates a BOM of each of the enterprises of each tier and the enterprises downstream of the target enterprise based on the order receiving and placing information 500. Details of a method of estimating the multi-tiered SC network formed of the enterprises, the items, and BOMs are described later.

After that, the SC risk detection module 122 searches the disclosed information 400 for a risk influencing the flows of the products in the generated current multi-tiered SC network (Step S15). Information on a found risk is included in the risk information 134. When the SC risk detection module 122 can access risk-related information in the non-disclosed information (secret information) on the user enterprises, the SC risk detection module 302 searches the non-disclosed information on the enterprises included in the current multi-tiered SC network for an existing related risk.

Types of risks to be searched for may be set by, for example, the SC risk detection module 122. For example, various types of risks which relate to the industrial accident, the natural disaster, the labor unrest, and the like and may influence the product supply may be specified. In the search for the related risk, the specified risk is searched for based on the information on each enterprise indicated by the user enterprise information 131. The SC risk detection module 122 can detect, from, for example, a location of an enterprise and a type and a place of occurrence of natural disaster, a natural disaster risk to this enterprise.

In another example, the SC risk detection module 122 may use a service for supplying information on a risk to a supply chain, and may acquire the information on the risk to the multi-tiered SC network from a provider of this service. Information on the user enterprises and the target risk is provided to the service enterprise in advance. The risk information may be provided from the service enterprise to the supply chain management apparatus 100 as required, and may be stored in the auxiliary storage device 203. The SC risk detection module 122 may search this risk information for information on the enterprises in the current multi-tiered SC network. The SC risk detection module 122 may specify an enterprise in the current multi-tiered SC network, and may acquire the risk information from the service enterprise.

When a risk to the current multi-tiered SC network does not exist (NO in Step S16), the output module 150 transmits information indicating this state to the enterprise terminal 301 via the communication module 140 and the network 200, and this flow is finished.

When a risk to the current multi-tiered SC network exists (YES in Step S16), the SC risk detection module 122 uses this risk, the multi-tiered SC network generated in Step S13 and Step S14, a lead time from order to delivery in the order receiving and placing information, and a production and sales plan of products dealt in by the target enterprise to execute SC simulation, to thereby calculate supplied amounts of products (Step S17). For example, it is assumed that the supply of the product from the influenced node is 0 owing to the risk.

The result of the SC simulation indicates information on nodes and times of occurrence of problems (for example, stockout) caused by the risk to occur in the target enterprise. The SC simulation is a widely-known technology, and a detailed description thereof is herein omitted. Without the execution of the simulation, the SC risk detection module 122 can track the multi-tiered SC network from the occurrence node of the risk to the node of the target enterprise, and refer to the information on the order receiving and placing lead times between nodes to acquire information on the nodes causing the problem of the target enterprise.

After that, the SC risk detection module 122 generates alert information indicating the nodes of the target enterprise at which problems may occur as a result of the risk and the times of occurrence of the problems. The output module 150 transmits the alert information to the enterprise terminal 301 via the communication module 140 and the network 200, and displays the alert information on the enterprise terminal 301 (Step S18).

The flowchart of FIG. 11A is connected to the flowchart of FIG. 11B via a connector A. With reference to FIG. 11B, the SC plan creation module 123 refers to the risk information acquired from, the recovery time information 133, or the disclosed information 400 or the non-disclosed information 302, to thereby estimate the recovery time of the risk (Step S21).

Further, the SC plan creation module 123 uses an SC planning system to create an SC network change plan which is intended for the target enterprise, and has the smallest risk to the target enterprise based on the recovery time of the risk in addition to the information used for the simulation in Step S16 (Step S23). This change plan changes information on the node of the target enterprise or the arcs directly coupled to the node of the target enterprise (arcs of target enterprise). The risk to the target enterprise is, for example, a supply delay time of the product dealt in by the target enterprise. A publicly-known simulator, a plan optimization tool, or the like can be used as the SC planning system, and a detailed description thereof is therefore omitted.

The SC plan creation module 123 acquires, from the target enterprise, information required to create the SC network change plan such as information on detailed order receiving and placing including transport path information in addition to a production plan and a sales plan of the products dealt in by the target enterprise. Those pieces of information are an example of information showing flows of products between enterprises. Moreover, as information which is required for the SC planning system to create the SC network change plan and cannot be acquired from the target enterprise or other information resources, default information set in advance may be used.

The SC plan creation module 123 determines, for example, a change plan having the shortest supply delay time of the product of the node having the problem to occur from SC network change plans such as a plan of switching the produced item in the target enterprise, a plan of changing transport means from Tier 1 to the target enterprise, and a plan of changing a destination of procurement of a specific product by the target enterprise from Tier 1.

The SC plan creation module 123 determines whether or not a risk caused by the generated best SC network change plan is equal to or lower than a criterion set in advance, for example, whether or not the supply delay time of the product is equal to or shorter than a criterion set in advance (Step S23). When the risk is equal to lower than the criterion (YES in Step S23), the output module 150 transmits the SC network change plan to the enterprise terminal 301 via the communication module 140 and the network 200, and displays the SC network change plan on the enterprise terminal 301 (Step S27).

When the risk of the SC network change plan exceeds the criterion (NO in Step S23), the SC network search module 124 searches for a substituting enterprise and a substituting item for the node which stops the supply due to the risk to occur from user enterprises outside the current multi-tiered SC network. As a result, it is possible to effectively find a substituting enterprise and a substituting item. The SC network search module 124 may include the enterprises in the current multi-tiered SC network in the search targets for the substituting enterprise and the substituting item.

The SC network search module 124 refers to the order receiving and placing information 500 to search for an item having the same name as that of the item of the substituted node which stops the supply from items of the enterprises outside the current multi-tiered SC network. When the same item is found, the SC network search module 124 determines a combination of that item and an enterprise dealing in that item as the substituting enterprise and the substituting item. The number of found combinations of the substituting enterprise and the substituting item may be one or more.

When the same item is not found, the SC network search module 124 searches for an item similar to the target item from a multi-tiered SC network of another enterprise in the same trade of the target enterprise. The SC network search module 124 refers to the user enterprise information 131 to search for another enterprise in the same trade. A multi-tiered SC network of another enterprise in the same trade can be estimated through the same method as that for the multi-tiered SC network of the target enterprise.

The SC network search module 124 refers to the item information 135 to determine an item similar to the target item. As shown in FIG. 8, the item information 135 indicates the attributes of each item. For example, an item which is of the same item type and has the number of matching attribute fields equal to or more than a threshold value may be determined as the similar item. In another example, the item information 135 may define similar items. The number of found combinations of the substituting enterprise and the substituting item may be one or more.

When a combination of the substituting enterprise and the substituting item cannot be found through the above-mentioned two methods, the SC network search module 124 identifies enterprises existing between the target enterprise node and the supply stop node in the current multi-tiered SC network, and searches for items similar to the target item from multi-tiered SC networks of other enterprises in the same trade of the identified enterprises. The determination method for the other enterprises in the same trade and the similar items and the estimation method for the multi-tiered SC network are as described above. Appropriate substituting node candidates can be found by searching for the substituting node candidates (combinations of enterprise and item) stepwise as described above.

The SC plan creation module 123 couples a node of the retrieved enterprise and item to the multi-tiered SC network of the target enterprise (Step S25), and creates a multi-tiered SC network change plan (Step S26). As described above, in this example, an enterprise which is not coupled to the current multi-tiered SC network of the target enterprise is coupled to the multi-tiered SC network.

The output module 150 transmits the SC network change plan to the enterprise terminal 301 via the communication module 140 and the network 200, and displays the SC network change plan on the enterprise terminal 301. The SC plan creation module 123 may receive specification of a node to be coupled by the user in the creation of the multi-tiered SC network change plan.

The SC plan creation module 123 may execute the SC simulation for each multi-tiered SC network change plan which couples one or a plurality of substituting node candidates, and may determine a change plan achieving the shortest delay in delivery date of the supply by the target enterprise. In the SC simulation, a production capability of the enterprise of the substituting node may be estimated from the order receiving and placing information, and one or a plurality of substituting nodes to be coupled may be determined such that a deficit number of the substituted items until the recovery is filled.

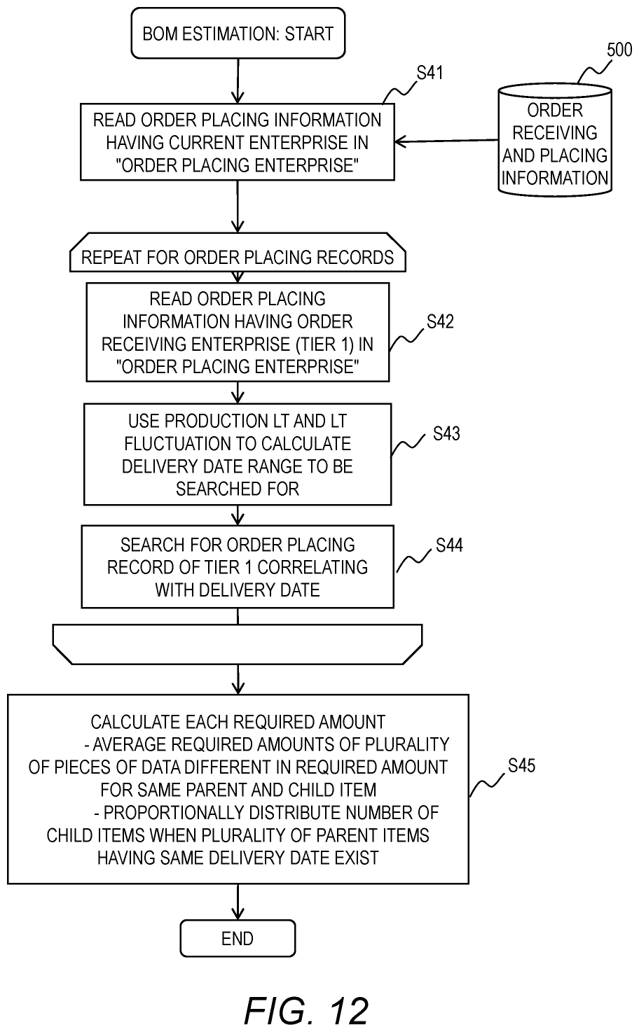

Description is now given of details of the method of estimating the BOMs in Step S13 of the flowchart of FIG. 11A. FIG. 12 is a flowchart of an example of the BOM estimation method. The flowchart of FIG. 12 shows an example of a method of estimating BOMs in upstream enterprises (for example, Tier 1 and Tier 2 in the case of the target enterprise of FIG. 1) of a selected one user enterprise (current enterprise). In the at least one embodiment of this specification, the BOMs are estimated from the order receiving and placing information 500.

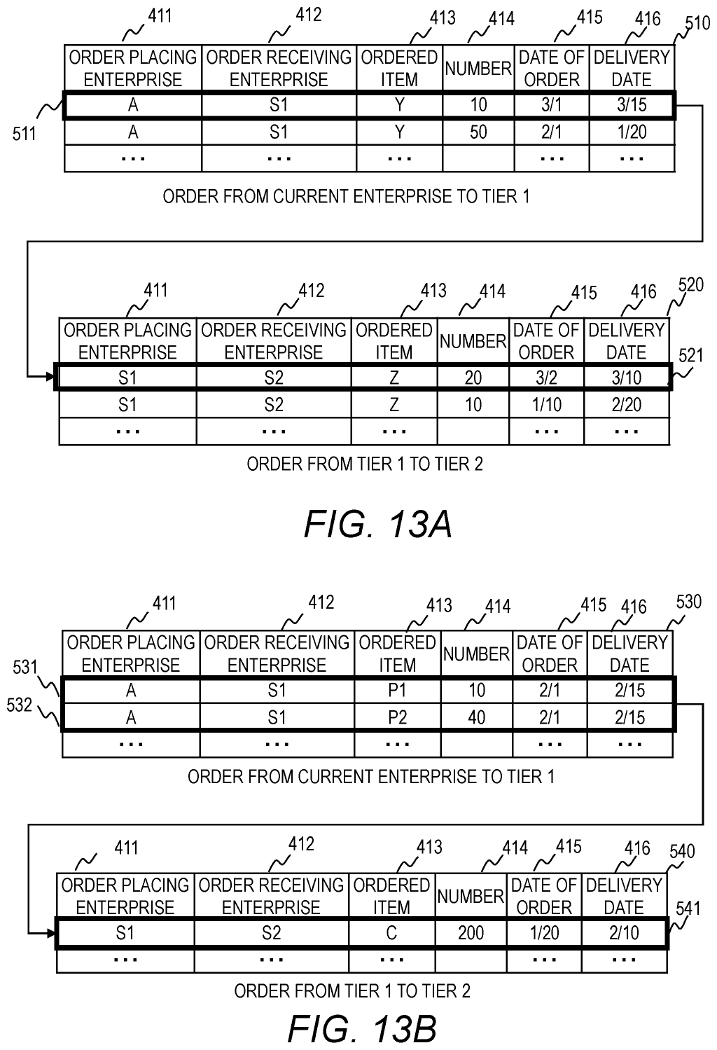

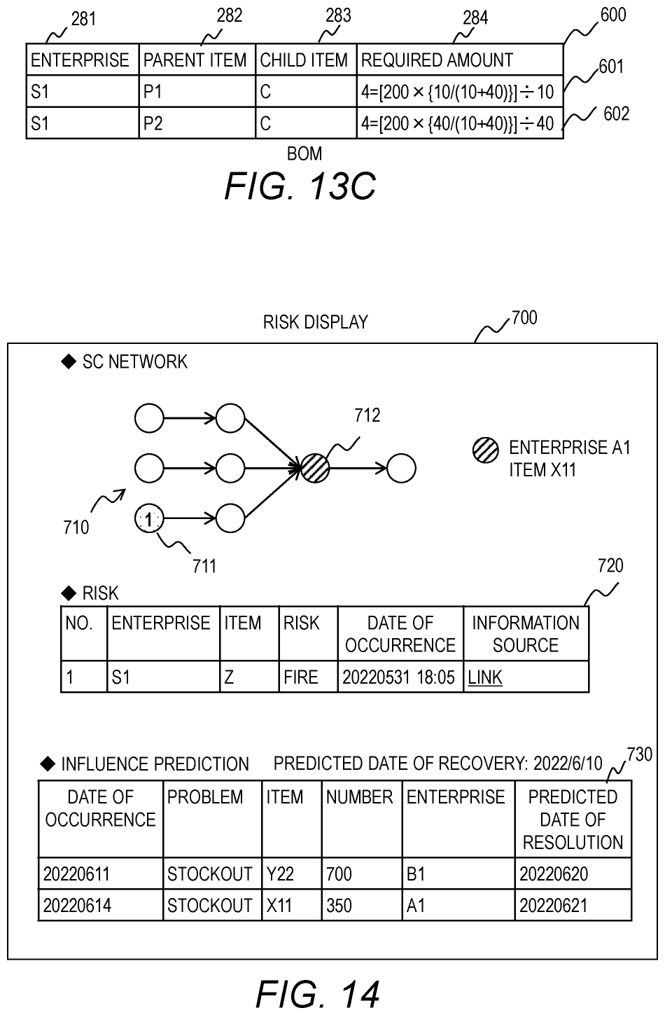

First, the SC network creation module 121 reads, from the order receiving and placing information 500, order placing information having the current enterprise in “order placing enterprise” (Step S41). FIG. 13A shows an example of order placing information 510 having the current enterprise in “order placing enterprise.” The configuration of the order placing information 510 is as described with reference to FIG. 10. This point applies to other pieces of order placing information. The order placing enterprise field 411 of the order placing information 510 indicates a current enterprise A. The order receiving enterprise field 412 thereof indicates all enterprises of Tier 1 which are direct destinations of the order placing of the current enterprise A.

With reference back to FIG. 12, the SC network creation module 121 executes processing steps of from Step S42 to Step S44 for each order placing record indicated by the order placing information 510 having the current enterprise A in “order placing enterprise.” First, the SC network creation module 121 reads order placing information having, in “order placing enterprise,” the order receiving enterprise (Tier 1) indicated by the order receiving enterprise field 412 of the order placing information 510 from the order receiving and placing information 500 (Step S42).

FIG. 13A shows an example of order placing information 520 having, in “order placing enterprise,” “order receiving enterprise” of an order placing record 511 of the order placing information 510 on the current enterprise A. The “order receiving enterprise” of the order placing information 510 on the current enterprise A is an enterprise on Tier 1 which directly receives an order from the current enterprise A. The order placing enterprise field 411 of the order placing information 520 indicates an enterprise S1 indicated by the order receiving enterprise field 412 of the order placing record 511, and the order receiving enterprise field 412 thereof indicates all destination enterprises of the orders placed by the enterprise S1.

With reference back to FIG. 12, the SC network creation module 121 uses a production lead time and a production lead time variation to calculate a delivery date range to be searched for the current order placing record (Step S43). More specifically, the SC network creation module 121 uses estimation values of the production lead time and the production lead time variation to calculate the delivery date range of order placing records relating to the current order placing record in the order placing information read in Step S42.

The production lead time represents a standard time required to produce a product after components are prepared. The production lead time variation represents a variation of the production lead time. In this case, it is assumed that the production lead time and the production lead time variation are specified in advance. The production lead time and the production lead time variation, for example, may be common to all products, or may be specified for each item type of the products.

In the example of FIG. 13A, an ordered item Y of the order placing record 511 has a production lead time of five days and a production lead time variation of plus-minus one day. The delivery date of the order placing record 511 is 3/15. Order placing records of the order placing information 520 on Tier 1 correlating with the delivery date of 3/15 are order placing records having delivery dates of from 3/9 to 3/11.

With reference back to FIG. 12, the SC network creation module 121 searches for order placing records of Tier 1 correlating, in terms of the delivery date, with the current order placing record (Step S44). Specifically, the SC network creation module 121 searches the order placing data on Tier 1 corresponding to the current record for order placing records within the above-mentioned delivery date range. The delivery date of the order placing record is indicated by the delivery date field 416.

In the example of FIG. 13A, a delivery date range which corresponds to the current order placing record 511 and is thus to be searched is from 3/9 to 3/11 as described above. The SC network creation module 121 searches the order placing information 520 on Tier 1 for order placing records which have the delivery date indicated by the delivery date field 416 in the range of from 3/9 to 3/11.

In FIG. 13A, an order placing record 521 is an order placing record satisfying this delivery date condition, and is estimated to correlate with the order placing record 511 in terms of the date of delivery. An ordered item “Z” indicated by the order placing record 521 is determined to be a material of the ordered item “Y” indicated by the current order placing record 511.

With reference back to FIG. 12, as described above, the SC network creation module 121 executes the processing steps of from Step S42 to Step S44 for each of all of the order placing records of the order placing information on the current enterprise, to thereby associate each of the order placing records correlating, in terms of the delivery date, with the order placing records of the order placing destinations (order receiving enterprises) of each of the order placing records.

After that, the SC network creation module 121 calculates a required amount of each material of each ordered item in the order placing information of the current enterprise (Step S45). The required amount is used to calculate the supplied amount in the SC simulation. The required amount is calculated from the numbers in the correlating order placing records. For example, in the example of FIG. 13A, the number of ordered items in the order placing record 511 is 10, and the number in the order placing record 521 is 20. It is assumed that a Tier 1 order placing record with which the order placing record 511 correlate is only the order placing record 521. Regarding the order placing record 511, a required amount of the child item “Z” corresponding to one unit of the parent item “Y” is 2.

In the at least one embodiment of this specification, the calculation of the required amount follows the following rules. (1) When there exist a plurality of order placing record pairs which are the same in parent and child items and different in required amount, an average of the required amounts among those order placing record pairs is estimated as a required amount between those parent and child items. (2) When there exist a plurality of order placing records of a parent item correlating with one order placing record of a child item, the number of the child item is proportionally distributed. As a result, it is possible to appropriately estimate the required amount of the child item for the parent item.

Regarding the rule (1), for example, it is assumed that there exist a plurality of order placing record pairs indicating the relationship between the parent item “Y” and the child item “Z.” The SC network creation module 121 calculates an average of the required amounts of the plurality of order placing record pairs, and determines the calculated value as the required amount of the child item “Z” for the parent item “Y.”

An example of the second rule (2) is now described. FIG. 13B shows an example of order placing information 530 of the current enterprise A and an example of order placing information 540 on the enterprise S1 on Tier 1. Two order placing records 531 and 532 of two parent items in the order placing information 530 correlate with an order placing record 541 of one child item in the order placing information 540 of the enterprise S1. In the example of FIG. 13B, delivery dates of the two order placing records 531 and 532 of the parent items are the same.

In the example of FIG. 13B, the number of child items C is proportionally distributed in accordance with the numbers of the two parent items P1 and P2. A ratio between the two parent items P1 and P2 is 1:4. Accordingly, ⅕ of the number of the child items C is allocated to the parent item P1, and ⅘ of the number of the child items C is allocated to the parent item P2.

FIG. 13C shows records in a BOM 600 calculated from the correlating order placing records 531, 532, and 541 of FIG. 13B. The BOM 600 has the same configuration as that of the BOM 280 of FIG. 5. A record 601 shows a relationship between the parent item P1 and the child item C. A record 602 shows a relationship between the parent item P2 and the child item C.

A required amount of the child item C for the parent item P1 is calculated as follows. As described above, the number of the child items C allocated to the parent item P1 is 200/5=40. The number of the parent items P1 is 10, and hence the required amount is 40/10=4. The number of the child items C allocated to the parent item P2 is 200*(4/5)=160. The number of the parent items P2 is 40, and hence the required amount is 160/40=4.

A method of estimating a BOM of a downstream enterprise in Step S14 is implemented by inverting a reference direction of the flow of the processing of FIG. 12. Specifically, in Step S41, order placing information having the current enterprise in “order receiving enterprise” is read. In Step S42, order placing information having the order placing enterprise in “order receiving enterprise” is read. For example, it is assumed that the current enterprise is an enterprise S2 in FIG. 13B, and a BOM of a downstream enterprise of the enterprise S2 is estimated. In Step S41, the order placing information 540 is read. In Step 42, the order placing information 530 is read. The calculation of required amounts in Step S43 is executed as described above.

Description is now given of an example of information which is generated by the supply chain management apparatus 100, and is presented to the user. FIG. 14 shows an example of a risk display screen 700 which presents a multi-tiered supply chain of a target enterprise and information on a risk thereto. The risk display screen 700 is displayed on a display device of the enterprise terminal 301 in Step S17 of the flowchart of FIG. 11A, for example. This screen may be displayed on the display device of the supply chain management apparatus.

The risk display screen 700 shows a partial directed graph 710 including a node 711 at which a risk has occurred and a node 712 of the enterprise A1 influenced by a stop of supply of products of the node 711 in the multi-tiered SC network of the target enterprise A1.

The risk display screen 700 further shows information 720 on the risk having occurred at the node 711. The information 720 on the risk includes an enterprise and an item of the node at which the risk has occurred, a type of the risk, a day of occurrence of the risk, and a link to an information source of the risk.

The risk display screen 700 further shows influence prediction information 730 indicating nodes to be influenced by the risk having occurred in the multi-tiered SC network 710. The influence prediction information 730 specifically shows predicted dates of recovery from the risk as well as information on the influenced nodes. Each record indicates the information on each influenced node. The influenced node is a node to be influenced by the supply stop of the node 711. In the example of FIG. 14, two nodes are influenced.

The influence prediction information 730 indicates a date of occurrence of the influence on the node, a problem caused by the influence, a node item, a number indicating a supply count planned in a period from the start of the influence to disappearance of the influence, an enterprise of the node, and a predicted date of resolution of the influence. Those fields can be obtained by inputting, to a publicly-known SC simulation, the SC network information 132, the recovery time information 133 on the risk, the risk information 134, and information on the production lead time.

FIG. 14 is shows an example of the risk information, and a part of the information may be omitted or other information may be presented. The supply chain management apparatus 100 may present, to the user, only information on the estimated multi-tiered SC network without the information on the risk. For example, a directed graph representing the multi-tiered SC network, information on each node and each arc, BOMs, and the like may be presented.

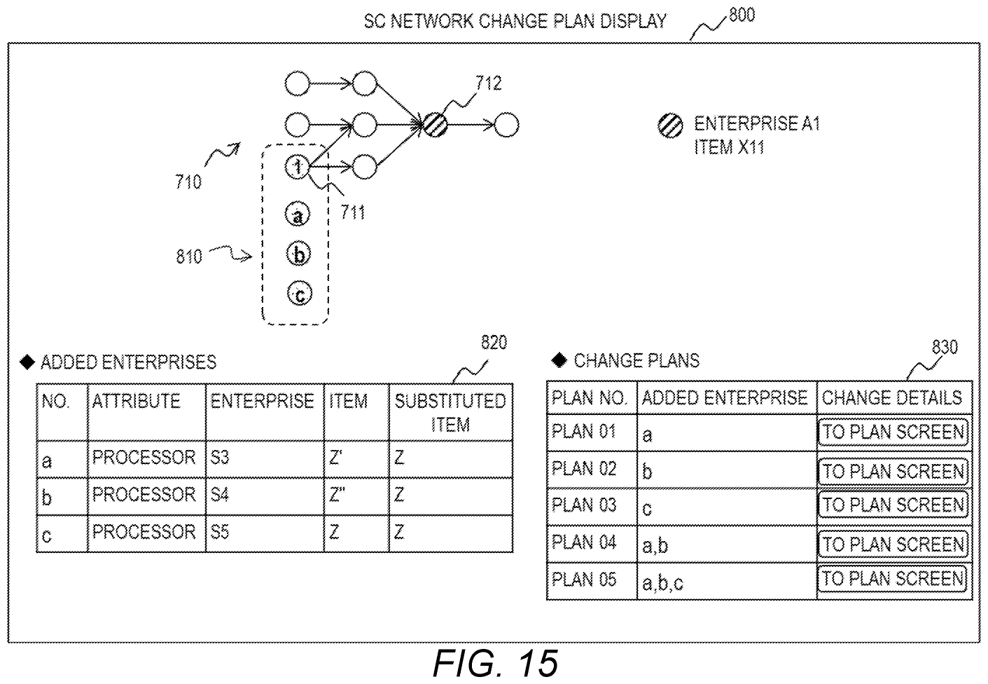

FIG. 15 shows an example of an SC network change plan display screen 800 which presents information on the SC network change plan. The SC network change plan display screen 800 is displayed on the display device of the enterprise terminal 301 in Step S27 of the flowchart of FIG. 11B, for example. This screen may be displayed on the display device of the supply chain management apparatus 100.

The SC network change plan display screen 800 presents substituting node candidates 810 of the node 711 in addition to the directed graph 710 of FIG. 14. Moreover, a list 820 shows information on each substituting node candidate 810. Specifically, the list 820 shows a business type (attribute), an enterprise name, an item, and a substituted item of an enterprise of the node.

The SC network change plan display screen 800 further includes a list 803 which allows the user to select, from a plurality of SC network change plans, a change plan for which detailed information is to be displayed. Each of the presented SC network change plans different from one another adds a different combination of substituting node candidates to the multi-tiered SC network. When any one of the SC network change plans is selected by the user, a detailed screen (not shown) of this SC network change plan is displayed.

The detailed screen may present, for example, a directed graph representing a changed multi-tiered SC network and a supply plan (a production site, a product to be produced at the production site, the number of produced products, a time of the production, the number of products to be shipped, and a time of the shipment). The supply plan can be obtained by inputting the SC network information 132 and a supply plan of the target enterprise into a publicly-known supply planning system.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

What is claimed is:

1. A supply chain management system, comprising:
one or more arithmetic devices; and
one or more storage devices configured to store programs executed by the one or more arithmetic devices,
wherein the one or more storage devices are configured to store user enterprise information for managing information on a plurality of enterprises including a target enterprise, and
wherein the one or more arithmetic devices are configured to:
create, by referring to information representing flows of products in the plurality of enterprises, supply chain network information including information on a directed graph representing a multi-tiered supply chain network including tiers upstream and downstream of the target enterprise, each of nodes of the directed graph representing an enterprise and an item;
acquire risk information on the multi-tiered supply chain network from one of disclosed information or non-disclosed information;
detect, in the directed graph, a risk occurrence node influenced by a risk indicated by the risk information and a node of the target enterprise influenced by a defect of product supply at the risk occurrence node based on the risk information and the user enterprise information;
search, by referring to the information representing the flows of the products in the plurality of enterprises, for a substituting node candidate for the risk occurrence node in a node group including a node of an enterprise outside the directed graph based on an item of the risk occurrence node; and
present information on a change plan of the multi-tiered supply chain network obtained by adding the substituting node candidate to the directed graph.

2. The supply chain management system according to claim 1, wherein the one or more arithmetic devices are configured to:
create, by referring to information on the target enterprise in the information representing the flows of the products in the plurality of enterprises, against the risk, a first change plan of changing information corresponding to a portion of the target enterprise in the multi-tiered supply chain network; and
present the first change plan when the first change plan satisfies a criterion set in advance.

3. The supply chain management system according to claim 1,
wherein the information representing the flows of the products in the plurality of enterprises includes order receiving and placing information among the plurality of enterprises, and
wherein the one or more arithmetic devices are configured to determine a relationship between a parent item and a child item in the multi-tiered supply chain network based on a delivery date in the order receiving and placing information.

4. The supply chain management system according to claim 3, wherein the one or more arithmetic devices are configured to calculate a required amount of the child item for one unit of the parent item based on the number of parent items and the number of child items in the order receiving and placing information.

5. The supply chain management system according to claim 1, wherein the one or more arithmetic devices are configured to select, as the substituting node candidate, a node of the same item as the item of the risk occurrence node.

6. The supply chain management system according to claim 1, wherein the one or more arithmetic devices are configured to:
determine, by referring to the user enterprise information, another enterprise in the same trade of the target enterprise; and
search for the substituting node candidate in a multi-tiered supply chain network of the another enterprise in the same trade.

7. The supply chain management system according to claim 1, wherein the one or more arithmetic devices are configured to:
determine, by referring to the user enterprise information, another enterprise in the same trade of an enterprise of a node between the risk occurrence node and the node of the target enterprise in the directed graph; and
search for the substituting node candidate in a multi-tiered supply chain network of the another enterprise in the same trade.

8. A supply chain management method, which is executed by a system,
the system being configured to store user enterprise information for managing information on a plurality of enterprises including a target enterprise,
the supply chain management method comprising:
creating, by the system, by referring to information representing flows of products in the plurality of enterprises, supply chain network information including information on a directed graph representing a multi-tiered supply chain network including tiers upstream and downstream of the target enterprise, each of nodes of the directed graph representing an enterprise and an item;
acquiring, by the system, risk information on the multi-tiered supply chain network from one of disclosed information or non-disclosed information;
detecting, by the system, in the directed graph, a risk occurrence node influenced by a risk indicated by the risk information and a node of the target enterprise influenced by a defect of product supply at the risk occurrence node based on the risk information and the user enterprise information;
searching, by the system, by referring to the information representing the flows of the products in the plurality of enterprises, for a substituting node candidate for the risk occurrence node in a node group including a node of an enterprise outside the directed graph based on an item of the risk occurrence node; and
presenting, by the system, information on a change plan of the multi-tiered supply chain network obtained by adding the substituting node candidate to the directed graph.
